(19) United States
(12) Patent Application Publication
(10) Pub. No.: US 2014/0347293 A1
(43) Pub. Date: Nov. 27, 2014

(54) METHOD FOR CONTROLLING DEVICE, DEVICE CONTROLLER, COMPUTER PROGRAM PRODUCT, AND ELECTRONIC DEVICE

(71) Applicant: Kabushiki Kaisha Toshiba, Tokyo (JP)

(72) Inventors: Hiroshi Kazawa, Akishima-shi (JP); Hideo Kataoka, Nerima-ku (JP)

(73) Assignee: Kabushiki Kaisha Toshiba, Tokyo (JP)

(21) Appl. No.: 14/268,798

(22) Filed: May 2, 2014

Related U.S. Application Data
(63) Continuation of application No. PCT/JP2013/064285, filed on May 22, 2013.

(51) Int. Cl. G06F 3/041; G06F 3/0346

(52) U.S. Cl. CPC G06F 3/0416; G06F 3/0346
USPC 345/173

(57) ABSTRACT

According to one embodiment, a method for controlling an electronic device by a device controller includes: detecting first movement of the device controller; receiving input of a contact operation performed by a user on a screen of the device controller; and transmitting, to the electronic device to be operated by the device controller, information on an amount of second movement determined by using an amount of the first movement. The amount of the second movement differs depending on a state of contact of the contact operation on the screen during detecting the first movement of the device controller.

### CROSS-REFERENCE TO RELATED APPLICATIONS

This application is a continuation of international application No. PCT/JP2013/064285, filed on May 22, 2013, which designates the United States, the entire contents of which are incorporated herein by reference.

### FIELD

Embodiments described herein relate generally to a method for controlling a device, a device controller, a computer program product, and an electronic device.

### BACKGROUND

In a conventional technology, a mobile device such as a smartphone is used as a remote controller, so that a user can control an electronic device such as a television by operating the mobile device. The mobile device is provided with an accelerometer in most cases. When the user moves the mobile device up and down, left and right, the accelerometer detects movement of the mobile device. This enables the user to control display on a screen of the electronic device.

In such a conventional technology, it is desirable to easily adjust control of the electronic device based on movement of the mobile device.

### BRIEF DESCRIPTION OF DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary configuration diagram illustrating a device control system according to a first embodiment;

FIG. 2 is an exemplary hardware configuration diagram of a mobile device in the first embodiment;

FIG. 3 is an exemplary block diagram illustrating a configuration of a digital television in the first embodiment.

FIG. 4 is an exemplary block diagram illustrating a functional configuration of the mobile device in the first embodiment;

FIG. 5 is an exemplary diagram illustrating a touch count on the mobile device and a state of movement of a pointer on a display module of the digital television in the first embodiment;

FIG. 6 is an exemplary diagram illustrating a touch count on the mobile device and another state of movement of the pointer on the display module of the digital television in the first embodiment;

FIG. 7 is an exemplary diagram illustrating a touch count on the mobile device and still another state of movement of the pointer on the display module of the digital television in the first embodiment;

FIG. 8 is an exemplary flowchart illustrating the procedure of device control processing performed by the mobile device in the first embodiment;

FIG. 9 is an exemplary diagram illustrating a touch position on a mobile device and a state of movement of a pointer on a display module of a digital television according to a second embodiment;

FIG. 10 is an exemplary diagram illustrating a touch position on the mobile device and another state of movement of the pointer on the display module of the digital television in the second embodiment;

FIG. 11 is an exemplary diagram illustrating a touch position on the mobile device and still another state of movement of the pointer on the display module of the digital television in the second embodiment;

FIG. 12 is an exemplary flowchart illustrating the procedure of device control processing performed by the mobile device in the second embodiment;

FIG. 13 is an exemplary diagram illustrating a touch count on the mobile device and a state of display of a pull-down menu on the display module of the digital television according to a modification of the second embodiment;

FIG. 14 is an exemplary diagram illustrating a touch count on the mobile device and another state of display of the pull-down menu on the display module of the digital television in the modification of the second embodiment;

FIG. 15 is an exemplary diagram illustrating a touch count on the mobile device and still another state of display of the pull-down menu on the display module of the digital television in the modification of the second embodiment;

FIG. 16 is an exemplary block diagram illustrating a functional configuration of a mobile device according to a third embodiment;

FIG. 17 is an exemplary block diagram illustrating a functional configuration of a display processor of a digital television according to a fourth embodiment;

FIG. 18 is an exemplary flowchart illustrating an example of the procedure of display control processing in the fourth embodiment; and

FIG. 19 is an exemplary flowchart illustrating another example of the procedure of display control processing in the fourth embodiment.

### DETAILED DESCRIPTION

In general, according to one embodiment, a method for controlling an electronic device by a device controller comprises: detecting first movement of the device controller; receiving input of a contact operation performed by a user on a screen of the device controller; and transmitting, to the electronic device to be operated by the device controller, information on an amount of second movement determined by using an amount of the first movement. The amount of the second movement differs depending on a state of contact of the contact operation on the screen during detecting the first movement of the device controller.

The following describes in detail a method for controlling a device, a device controller, a computer program, and an electronic device according to embodiments with reference to the accompanying drawings.

### First Embodiment

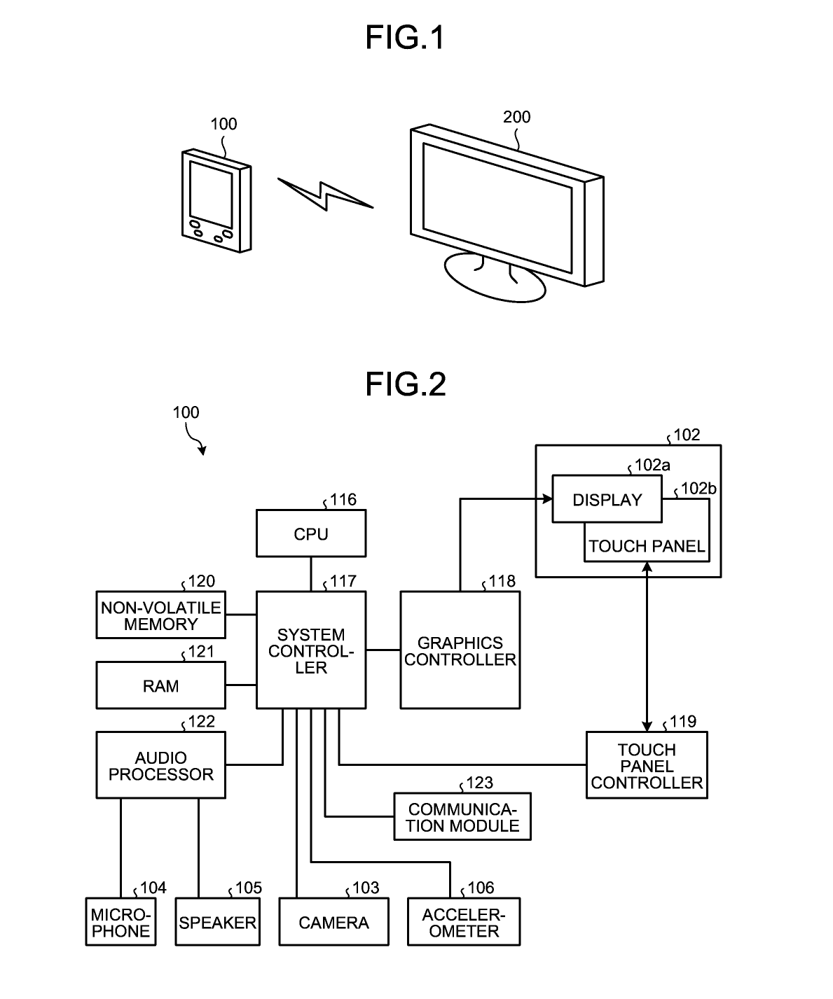

As illustrated in FIG. 1, a device control system according to a first embodiment comprises a mobile device 100 as a device controller and a digital television 200 as an electronic device that are connected to each other via a wireless network such as a wireless local area network (LAN). The mobile device 100 according to the first embodiment is a device held by a user in a hand to give operating instructions, and used as a remote controller that remotely performs various types of control of the digital television 200.

Although the first embodiment describes the digital television 200 that comprises a receiving tuner for digital broadcasting as an example of the electronic device, the electronic device is not limited to this. The electronic device may be a device, such as a hard disk recorder or a set-top box, that comprises a tuner receiving broadcast waves, and performs processing on video images and outputs them to an externally connected display device, or may be a device such as a monitor that does not comprise a tuner and that uses an external tuner to receive video images and sounds. The electronic device may be a device other than the devices such as the digital television 200, the hard disk recorder, and the set-top box.

Although the first embodiment describes the mobile device 100 as an example of the device controller, the device controller is not limited to this. The device controller may be a device other than the mobile device 100.

The mobile device 100 according to the first embodiment comprises a display screen. The mobile device 100 is implemented as a smartphone, a tablet computer, or a slate device, for example.

As illustrated in FIG. 2, the mobile device 100 comprises, as a hardware configuration, a display module 102, a central processing unit (CPU) 116, a system controller 117, a graphics controller 118, a touch panel controller 119, a non-volatile memory 120, a random access memory (RAM) 121, an audio processor 122, a microphone 104, a speaker 105, a camera 103, a communication module 123, and an accelerometer 106.

The display module 102 comprises a display 102a and a touch panel 102b that are combined with each other to constitute what is called a touch screen. The display 102a is, for example, a liquid crystal display (LCD), or an organic electro luminescence (EL) display.

The touch panel 102b detects touch operations (contact operations) performed by a user with a finger or a stylus on the display 102a that are measurable as a change in capacitance. The touch panel 102b receives the operating instructions in two-dimensional directions input with the touch operations. The touch panel 102b detects the number of touch points (contact points) on which the user performs a touch operation on a screen of the display 102a, and detects a touch position (contact position) on the screen for each of the touch points.

The non-volatile memory 120 stores therein an operating system, various application programs, various types of data required to execute the computer programs, and the like. The CPU 116 is a processor that controls operation of the mobile device 100, and controls components of the mobile device 100 via the system controller 117. The CPU 116 executes the operating system and the application programs that are loaded from the non-volatile memory 120 onto the RAM 121 to implement functional blocks (see FIG. 2) to be described later. The RAM 121 provides the CPU 116 with a work area as a main memory of the mobile device 100 when the CPU 116 executes the computer programs.

The CPU 116, for example, executes the operating system and the application programs that are loaded from the non-volatile memory 120 onto the RAM 121 to implement functions to control the modules of the mobile device 100.

The system controller 117 comprises a built-in memory controller that controls access to the non-volatile memory 120 and the RAM 121. The system controller 117 has a function to communicate with the graphics controller 118, the touch panel controller 119, and the audio processor 122. The system controller 117 has a function to receive a captured image from the camera 103. The system controller 117 has a function to obtain various types of information from outside of the mobile device 100 by using the communication module 123.

The graphics controller 118 is a display controller that controls the display 102a of the display module 102. The touch panel controller 119 controls the touch panel 102b to obtain the number of touch points (hereinafter referred to as “touch count”) and position coordinate data (coordinates of a touch position) indicating a touch position for each touch point from the touch panel 102b, and sends the touch count to a touch determination module 212 to be described later.

The microphone 104 inputs sound, and the speaker 105 outputs sound. The camera 103 captures an image of a subject while the user holds the mobile device 100 toward the subject, and outputs the captured image.

Under the control of the CPU 116, the audio processor 122 performs audio processing such as voice synthesis to generate sound such as an audio guidance, and outputs the sound from the speaker 105. The audio processor 122 also performs processing on sound collected by the microphone 104.

Under the control of the CPU 116, the communication module 123 performs wireless communication with the digital television 200 and external devices, and performs communication via a network such as the Internet. In the first embodiment, the communication module 123 wirelessly transmits various control commands from the mobile device 100 to the digital television 200.

The accelerometer 106 is a motion sensor that detects movement of the mobile device 100. Specifically, the accelerometer 106 detects direction (X, Y, and Z directions) and magnitude of acceleration given to the mobile device 100 from outside, and outputs them as a detection signal to the CPU 116. Instead of the accelerometer 106, a sensor may be used that can detect movement of the mobile device 100 such as a gyroscope that detects angular velocity (rotation angle) of the mobile device 100. The mobile device 100 may be provided with the gyroscope and a bearing sensor that detects bearings of the mobile device 100 in addition to the accelerometer 106.

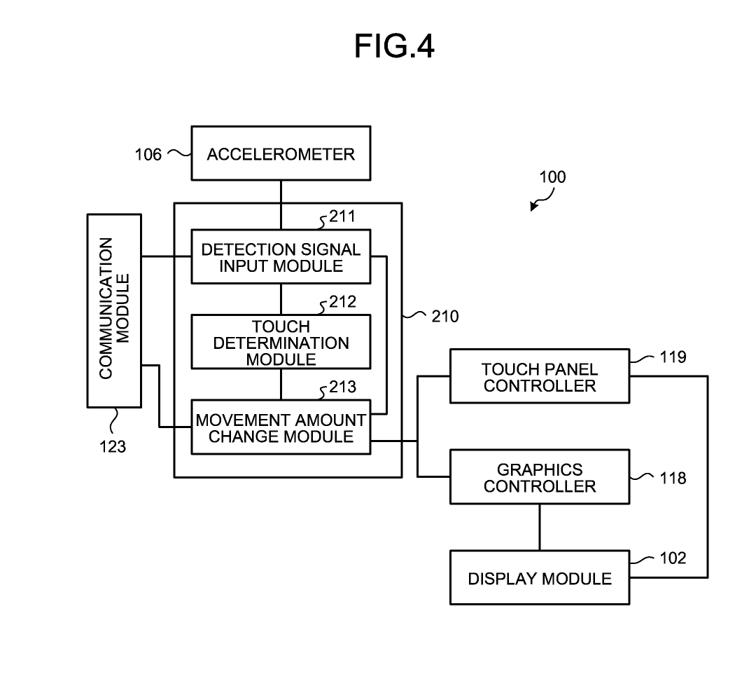

The mobile device 100 implements modules in a function module 210 illustrated in FIG. 4 to be described later by executing the computer programs (operating system and application programs) stored in the non-volatile memory 120 by the CPU 116.

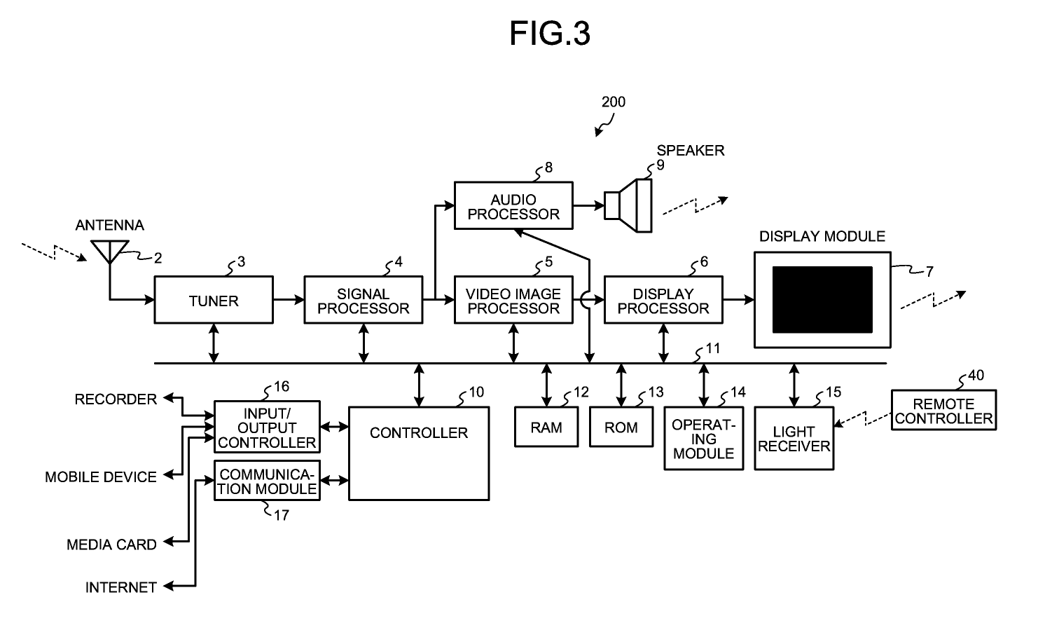

Next, described is the digital television 200. As illustrated in FIG. 3, the digital television 200 according to the first embodiment mainly comprises an antenna 2, a tuner 3 for receiving digital broadcasting, a signal processor 4, a video image processor 5, a display processor 6, a display module 7, an audio processor 8, a speaker 9, a controller 10, a communication line 11, a RAM 12, a read only memory (ROM) 13, an operating module 14, a light receiver 15, an input/output controller 16, and a communication module 17.

The antenna 2 receives digital broadcasting such as BS broadcasting, CS broadcasting, and terrestrial broadcasting. The tuner 3 selects a channel that the user specifies for watching. The signal processor 4 receives signals demodulated at the tuner 3 or signals input from the input/output controller 16 as various digital signals and performs processing on the digital signals under the control of the controller 10. The signal processor 4 separates input signals into video signals and audio signals, and outputs the video signals to the video image processor 5, and the audio signals to the audio processor 8.

The video image processor 5 performs processing, for example, to adjust the video signals received from the signal processor 4 so that the video signals are displayed in a proper screen size, and to remove noises contained in the video signals to improve quality of a video image.

The display processor 6 performs processing to display video signals output from the video image processor 5 on the display module 7. The display processor 6 superimposes on-screen display (OSD) such as character information on the video signals output from the video image processor 5. The display module 7 displays the video signals on a screen. The user watches the screen on the display module 7 to watch a television image.

The audio processor 8 performs acoustic processing on audio signals and amplifies the audio signals. The speaker 9 outputs the audio signals as sound. The user listens to the sound output from the speaker 9 to listen to television sound.

The controller 10 controls each module of the digital television 200. Because the controller 10 is a processing unit that can perform sequence processing, the controller 10 loads the computer programs stored on the ROM 13 onto the RAM 12 and sequentially executes them, so that the controller 10 outputs control signals to each module of the digital television 200 to centrally control the operation of the digital television 200.

The communication line 11 connects the tuner 3, the signal processor 4, the video image processor 5, the display processor 6, the audio processor 8, and the controller 10 with each other, so that data is transferred between the controller 10 and the tuner 3, the signal processor 4, the video image processor 5, the display processor 6, and the audio processor 8. The communication line 11 may be, for example, IIC-BUS. The RAM 12 and the ROM 13 store various types of data therein, and the data is transferred between the controller 10, and the RAM 12 and the ROM 13.

The operating module 14 is a switch that receives operating instructions of the user. The light receiver 15 receives a signal sent by a remote controller 40 (hereinafter simply referred to as “remote 40”) when the remote 40 receives an operating instruction from the user. The user can operate the digital television 200 and devices connected to the digital television 200 by operating buttons and keys on the remote 40. As described above, the first embodiment explains an example in which the mobile device 100 is used as the remote controller.

The communication module 17 has a function to communicate with devices such as the mobile device 100 via a network such as a wireless LAN.

Next, described is a functional configuration of the mobile device 100. As illustrated in FIG. 4, the mobile device 100 comprises, as the functional configuration, the accelerometer 106, the display module 102, the touch panel controller 119, the graphics controller 118, and the communication module 123, which are described above, and also comprises a detection signal input module 211, the touch determination module 212, and a movement amount change module 213 as the function module 210.

The detection signal input module 211 receives magnitude and direction of acceleration from the accelerometer 106, and obtains an amount and a direction of movement of the mobile device 100 from a change in the received magnitude and direction of acceleration over time. When the accelerometer 106 detects movement of the mobile device 100, the detection signal input module 211 sends a signal indicating the movement of the mobile device 100 to the touch determination module 212, and sends an amount of movement of the mobile device 100 to the movement amount change module 213. The detection signal input module 211 sends a direction of movement of the mobile device 100 to the communication module 123.

When the touch determination module 212 receives the signal indicating the movement of the mobile device 100 from the detection signal input module 211, the touch determination module 212 determines a state of contact of a touch operation performed on the display 102a. The state of contact may be any state of contact between the display 102a and an object (a finger of the user, or a stylus, for example) and is determined from at least one state of information such as the number of contact points, the area of a contact point, the position of a contact point, the type of an object that touches the display 102a, or the sensor that detects contact on the display 102a. The following specifically describes an example in which the touch determination module 212 obtains a touch count, as a state of contact, that is received from the touch panel controller 119.

The movement amount change module 213 changes an amount of movement received from the detection signal input module 211 depending on a touch count as a state of contact. Specifically, the movement amount change module 213 changes the amount of movement to a smaller value when the touch count is a larger number.

For example, assuming that n (n is 0 or a natural number) denotes a touch count, the movement amount change module 213 changes the amount of movement to a value obtained by a formula 1 below. It should be noted that the calculation method to change the amount of movement is not limited to Formula 1.

Amount of movement after change=amount of movement×[1/(n+1)] (1)

According to Formula 1, when the touch count is zero, that is, the user does not touch the display 102a, the amount of movement is not changed, whereas when the touch count is a larger number, the amount of movement is changed to a smaller value inversely proportional to the touch count.

The movement amount change module 213 sends the amount of movement after change to the communication module 123.

The communication module 123 wirelessly transmits, to the digital television 200, the amount of movement received from the movement amount change module 213 and the direction of movement of the mobile device 100 received from the detection signal input module 211 as information on the amount of movement. The communication module 123 includes the amount of movement and the direction of movement in a pointing command that is an instruction to move a pointer (cursor) for the amount of movement in the direction of movement, and transmits the pointing command to the digital television 200.

The digital television 200 performs processing in accordance with operation determined on the basis of the amount of movement and the direction of movement as information on the amount of movement received from the mobile device 100. Specifically, in the digital television 200, the display processor 6 moves a pointer displayed on the display module 7 in a direction of movement specified by the pointing command received from the mobile device 100 for a distance proportional to an amount of movement specified by the pointing command. In other words, the display processor 6 of the digital television 200 moves the pointer on the display module 7 for a longer distance when the amount of movement is a larger value.

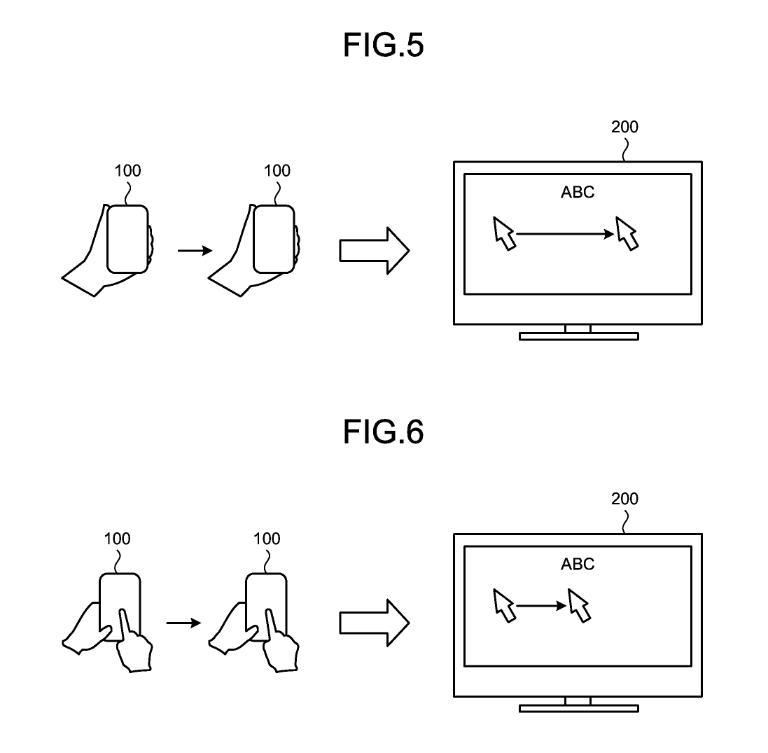

FIGS. 5 to 7 are diagrams each illustrating a touch count on the mobile device 100 and a state of movement of the pointer on the display module 7 of the digital television 200. FIGS. 5 to 7 illustrate cases in which the touch count is zero, the touch count is one, and the touch count is two, respectively.

As illustrated in FIG. 5, when a user moves the mobile device 100 without touching the display 102a thereof (touch count is zero), the pointer on the display module 7 of the digital television 200 is moved for an amount, which is determined as a reference amount of movement. As illustrated in FIG. 6, when the user moves the mobile device 100 with a forefinger touching the display 102a of the mobile device 100 (touch count is one), the movement amount change module 213 of the mobile device 100 changes the amount of movement to a smaller value according to the formula 1, so that the amount of movement of the pointer on the digital television 200 is smaller than the reference amount of movement illustrated in FIG. 5.

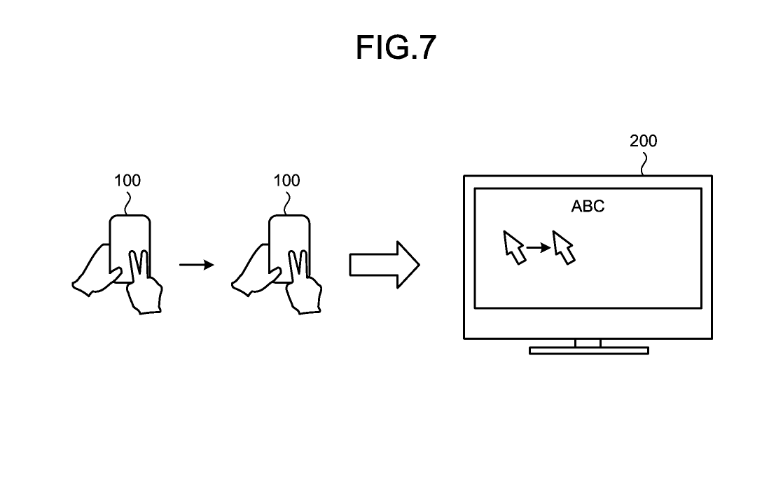

As illustrated in FIG. 7, when the user moves the mobile device 100 with a forefinger and a middle finger touching the display 102a of the mobile device 100 (touch count is two), the movement amount change module 213 of the mobile device 100 changes the amount of movement to a much smaller value according to the formula 1, so that the amount of movement of the pointer on the digital television 200 is smaller than the amount of movement illustrated in FIG. 6. In short, as the touch count increases, an amount of movement calculated from a detection signal sent from the accelerometer 106 is changed to a smaller value, thus the amount of movement of the pointer on the display module 7 of the digital television 200 decreases.

As described above, when the touch count is a larger number, the amount of movement of the mobile device 100 is changed to a smaller value. This means, in other words, that sensitivity of the accelerometer 106 is decreased depending on the touch count.

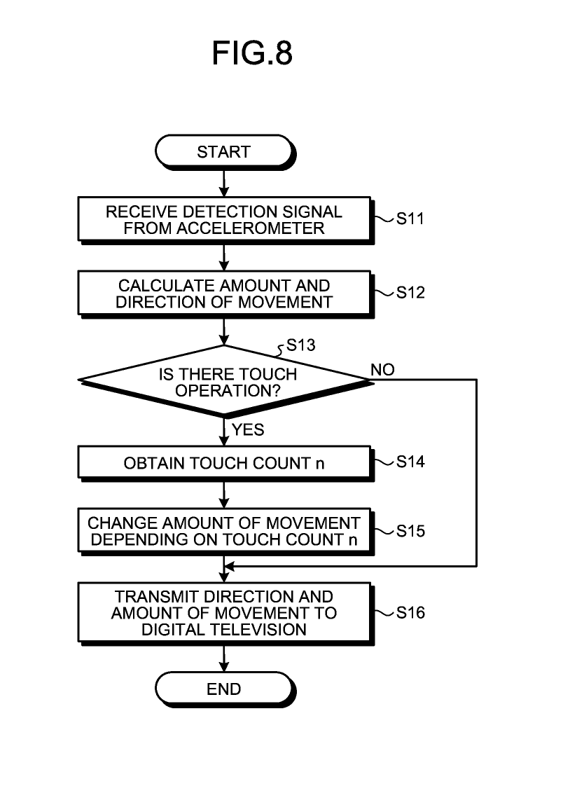

Next, with reference to FIG. 8, described is device control processing performed by the mobile device 100 according to the first embodiment that is configured as described above.

First, the detection signal input module 211 receives a detection signal (magnitude and direction of acceleration) from the accelerometer 106 (S11). The detection signal input module 211 calculates an amount and a direction of movement of the mobile device 100 from a change in the received magnitude and direction of acceleration over time (S12).

The touch determination module 212 determines, from input received from the touch panel controller 119, whether there is a touch operation performed by a user on the display 102a (S13). When the touch determination module 212 determines that there is no touch operation on the display 102a (No at S13), the process proceeds to S16. At S16, the communication module 123 transmits the amount and the direction of movement of the mobile device 100 obtained at S12 to the digital television 200 (S16).

When the touch determination module 212 determines, at S13, that there is a touch operation on the display 102a (Yes at S13), the touch determination module 212 obtains a touch count n from the touch panel controller 119 (S14).

The movement amount change module 213 changes the amount of movement calculated at S12 according to the formula 1 (S15). This processing changes the amount of movement depending on the touch count.

The communication module 123 includes the amount of movement changed at S15, and the direction of movement of the mobile device 100 obtained at S12 in a pointing command, and transmits the pointing command to the digital television 200 (S16).

The digital television 200 receives, at the communication module 17, the amount and the direction of movement contained in the pointing command as information on the amount of movement. The display processor 6 moves the pointer on the display module 7 in the direction of movement for the amount of movement specified in the pointing command, and displays the pointer.

In the first embodiment, when a user moves the mobile device 100 while touching the display 102a (touch panel 102b) to move the pointer on the display module 7 of the digital television 200, the mobile device 100 changes an amount of movement of the mobile device 100 depending on the touch count to change an amount of movement of the pointer on the digital television 200. This allows the user to easily adjust the amount of movement of the pointer on the digital television 200 without performing extra operation on a setting menu such as a control panel on the digital television 200 to change the amount of movement of the pointer so that it corresponds to the amount of movement of the mobile device 100. Thus, according to the first embodiment, the user can easily adjust control of the electronic device such as the digital television 200 based on movement of the mobile device 100.

### Modification

Although the reference amount of movement of the pointer on the digital television 200 is obtained when the touch count on the mobile device 100 is zero, and the amount of movement of the pointer is decreased to a smaller value than that of the reference amount of movement as the touch count increases in the first embodiment, the embodiment is not limited to this. For example, when the touch count is two, the amount of movement of the pointer is determined as a reference amount of movement, which is also the amount of movement when the touch count is zero. In this case, the movement amount change module 213 may be configured to change the amount of movement of the pointer to a smaller amount than the reference amount when the touch count is one, and to a larger amount than the reference amount when the touch count is three or larger, whereby the amount of movement increases with the touch count.

Although the amount of movement of the pointer is decreased as the touch count on the mobile device 100 increases in the first embodiment, the embodiment is not limited to this. For example, the movement amount change module 213 may be configured to increase the amount of movement of the pointer as the touch count increases.

### Second Embodiment

In the first embodiment, the amount of movement is changed depending on the touch count on the touch panel 102b of the mobile device 100, whereas in a second embodiment, the amount of movement is changed depending on a touch position on the touch panel 102b.

In the second embodiment, the hardware configuration and the functional configuration of the mobile device 100, and the configuration of the digital television 200 are the same as those in the first embodiment.

When the touch determination module 212 according to the second embodiment receives a signal from the detection signal input module 211 indicating movement of the mobile device 100, the touch determination module 212 obtains, as a state of contact, coordinates of a touch position input from the touch panel controller 119.

The movement amount change module 213 changes an amount of movement input from the detection signal input module 211 depending on the coordinates of a touch position as a state of contact. Specifically, the movement amount change module 213 changes the amount of movement to a smaller value as the coordinates of a touch position shift from the lower end of the display 102a to the upper end thereof.

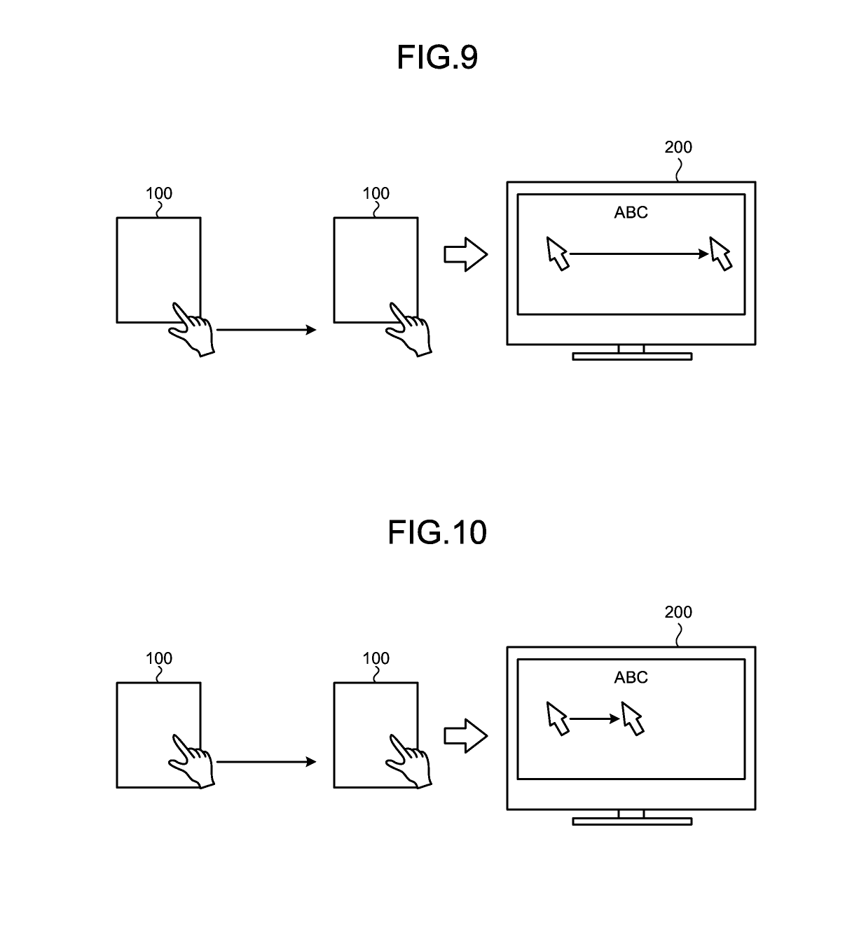

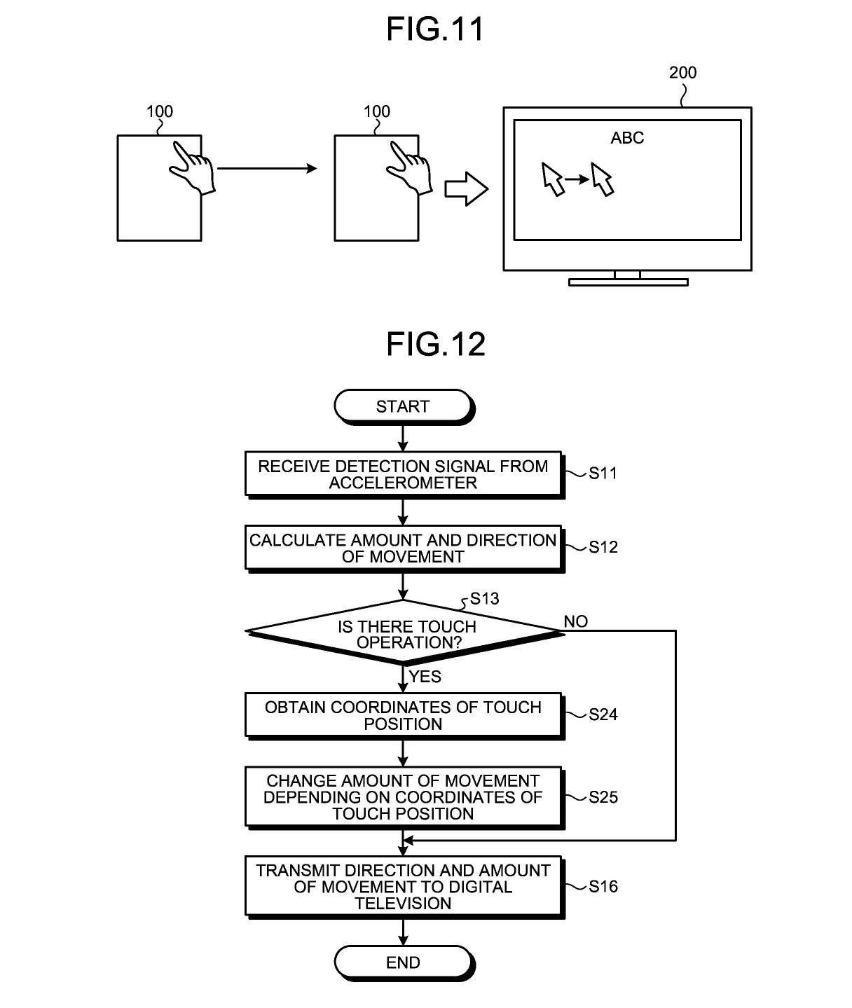

FIGS. 9 to 11 are diagrams each illustrating a touch position on the mobile device 100 and a state of movement of the pointer on the display module 7 of the digital television 200. FIG. 9 illustrates a case in which the touch position is adjacent to the lower end of the display 102a, FIG. 10 illustrates a case in which the touch position is in the central part of the display 102a, and FIG. 11 illustrates a case in which the touch position is adjacent to the upper end of the display 102a.

As illustrated in FIG. 9, when a user moves the mobile device 100 while touching a part adjacent to the lower end of the display 102a thereof, the pointer on the display module 7 of the digital television 200 is moved for an amount, which is determined as a reference amount of movement. As illustrated in FIG. 10, when the user moves the mobile device 100 while touching the central part of the display 102a thereof, the movement amount change module 213 of the mobile device 100 changes the amount of movement to a smaller value, so that the amount of movement of the pointer on the digital television 200 is smaller than the reference amount of movement illustrated in FIG. 9.

As illustrated in FIG. 11, when the user moves the mobile device 100 while touching a part adjacent to the upper end of the display 102a thereof, the movement amount change module 213 of the mobile device 100 changes the amount of movement to a much smaller value, so that the amount of movement of the pointer on the digital television 200 is smaller than the amount of movement illustrated in FIG. 10. In short, as the touch position is closer to the upper end of the display 102a, the amount of movement calculated from a detection signal sent from the accelerometer 106 is changed to a smaller value, thus the amount of movement of the pointer on the display module 7 of the digital television 200 decreases.

Next, with reference to FIG. 12, described is device control processing performed by the mobile device 100 according to the second embodiment that is configured as described above.

Processing from reception of a detection signal sent from the accelerometer 106 at the detection signal input module 211 to determination whether there is a touch operation at the touch determination module 212 (S11 to S13) in the second embodiment is performed in the same manner as in the first embodiment.

At S13, when the touch determination module 212 determines that there is a touch operation (Yes at S13), the touch determination module 212 obtains coordinates of a touch position from the touch panel controller 119 (S24).

The movement amount change module 213 changes the amount of movement calculated at S12 depending on the coordinates of a touch position (S25). In other words, the movement amount change module 213 changes the amount of movement to a smaller value when the coordinates of a touch position is in a closer position to the upper end of the display 102a.

The communication module 123 transmits the amount of movement changed at S25, and the direction of movement of the mobile device 100 obtained at S12 to the digital television 200 (S16).

In the digital television 200, the communication module 17 receives the amount and the direction of movement, and the display processor 6 moves the pointer on the display module 7 in the direction of movement for the amount of movement specified in the pointing command, and displays the pointer.

In the second embodiment, when a user moves the mobile device 100 while touching the display 102a (touch panel 102b) to move the pointer on the display module 7 of the digital television 200, the mobile device 100 changes an amount of movement of the mobile device 100 depending on coordinates of a touch position to change an amount of movement of the pointer on the digital television 200. This allows the user to easily adjust the amount of movement of the pointer on the digital television 200 without performing extra operation on a setting menu such as a control panel on the digital television 200 to change the amount of movement of the pointer so that it corresponds to the amount of movement of the mobile device 100. Thus, according to the second embodiment, the user can easily adjust control of the electronic device such as the digital television 200 based on movement of the mobile device 100.

### Modification

Although the amount of movement of the pointer is decreased as the coordinates of a touch position on the mobile device 100 shift from the lower end to the upper end of the display 102a in the second embodiment, the embodiment is not limited to this. For example, the movement amount change module 213 may be configured to increase the amount of movement of the pointer as the coordinates of a touch position on the mobile device 100 shift from the lower end to the upper end of the display 102a.

As another example, the movement amount change module 213 may be configured to decrease the amount of movement of the pointer as the coordinates of a touch position on the mobile device 100 shift from the central part to the lower end and to the upper end of the display 102a.

As still another example, the movement amount change module 213 may be configured to decrease or increase the amount of movement of the pointer as the coordinates of a touch position on the mobile device 100 shift from the left end to the right end of the display 102a.

Although the digital television 200 moves the pointer on the display module 7 according to the amount of movement received from the mobile device 100 in the first and the second embodiments described above, the embodiments are not limited to this. For example, the display processor 6 of the digital television 200 can be configured to change the number of items contained in a pull-down menu displayed on the display module 7 depending on the amount of movement received from the mobile device 100. In this case, the mobile device 100 transmits a pull-down menu display command comprising the amount and the direction of movement to the digital television 200.

For example, the display processor 6 can be configured to change the amount of movement of the mobile device 100 to a smaller value as the touch count on the display 102a of the mobile device 100 increases. The digital television 200 receives the amount of movement thus changed to display a smaller number of items of the pull-down menu on the display module 7 accordingly.

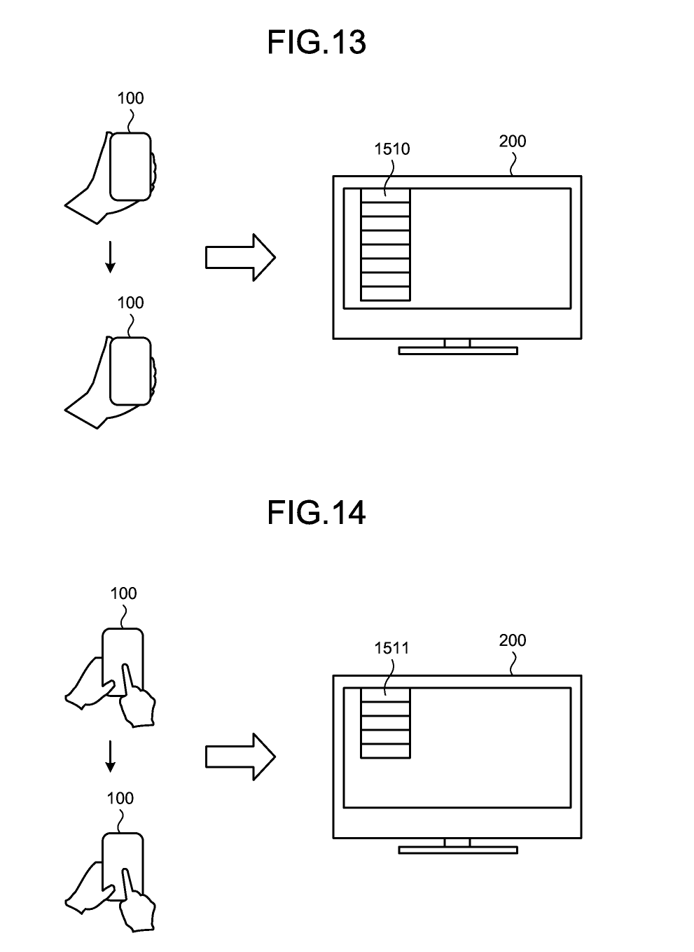

FIGS. 13 to 15 are diagrams each illustrating a touch count on the mobile device 100 and a state of display of a pull-down menu on the display module 7 of the digital television 200. FIGS. 13 to 15 illustrate cases in which the touch count is zero, the touch count is one, and the touch count is two, respectively.

Assume that the movement amount change module 213 changes the amount of movement to a smaller value as the touch count increases as in the case of the first embodiment. Assume also that the display processor 6 of the digital television 200 displays a smaller number of items contained in the pull-down menu as the amount of movement contained in the pull-down menu display command received from the mobile device 100 decreases.

As illustrated in FIG. 13, when a user moves the mobile device 100 downwards without touching the display 102a of the mobile device 100 (touch count is zero), the display module 7 of the digital television 200 displays a pull-down menu 1510 that contains eight items.

As illustrated in FIG. 14, when the user moves the mobile device 100 downwards with a forefinger touching the display 102a of the mobile device 100 (touch count is one), the movement amount change module 213 of the mobile device 100 changes the amount of movement to a smaller value, so that the digital television 200 displays a pull-down menu 1511 that contains five items, the number of which is smaller than the number of items illustrated in FIG. 13.

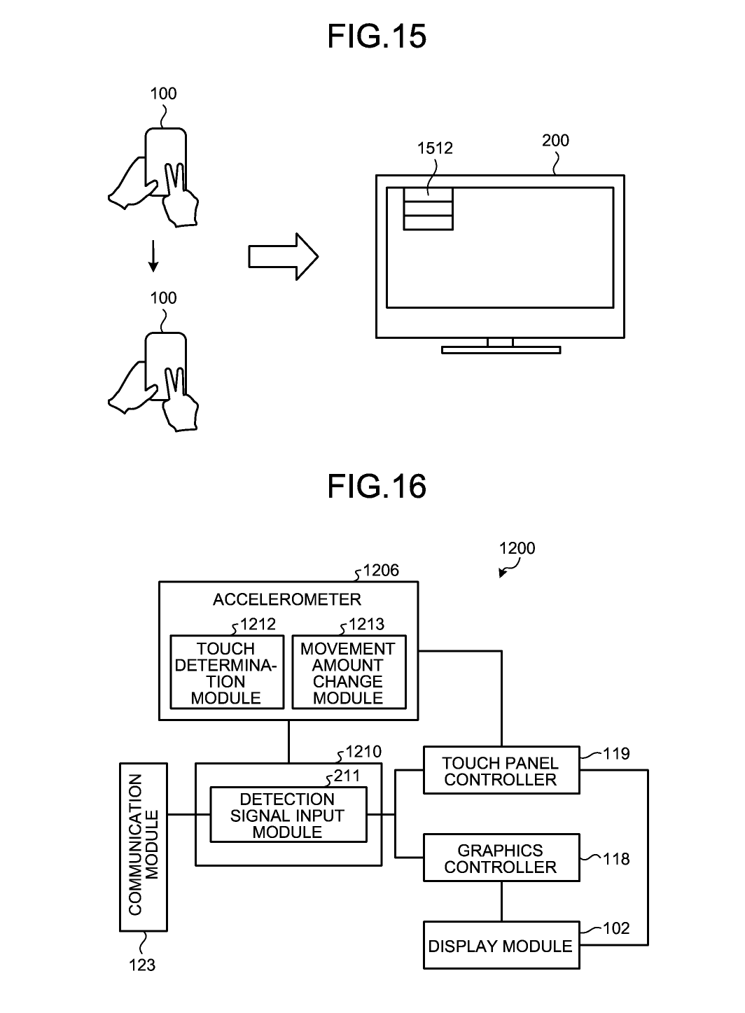

As illustrated in FIG. 15, when the user moves the mobile device 100 downwards with a forefinger and a middle finger touching the display 102a of the mobile device 100 (touch count is two), the movement amount change module 213 of the mobile device 100 changes the amount of movement to a much smaller value, so that the digital television 200 displays a pull-down menu 1512 that contains three items, the number of which is smaller than the number of items illustrated in FIG. 14.

In the present modification, when a user moves the mobile device 100 downwards while touching the display 102a to display a pull-down menu on the display module 7 of the digital television 200, the mobile device 100 changes the amount of movement depending on the touch count to change the number of items in the pull-down menu displayed on the digital television 200. This allows the user to easily adjust the number of items in the pull-down menu displayed on the digital television 200 without performing extra operation on a setting menu such as a control panel on the digital television 200 to change the number of items in the pull-down menu so that it corresponds to the amount of movement of the mobile device 100.

### Third Embodiment

In the first and the second embodiments and the modifications thereof, the function module 210 receives a detection signal from the accelerometer 106 to obtain an amount of movement of the mobile device 100, and changes the amount of movement depending on a state of contact of a touch operation performed on the display 102a. In a third embodiment, a module in an accelerometer receives a detection signal to obtain an amount of movement of the mobile device 100, and the module changes the amount of movement depending on a state of contact of a touch operation performed on the display 102a.

In the third embodiment, the hardware configuration of a mobile device 1200, and the configuration of the digital television 200 are the same as those of the first and the second embodiments.

As illustrated in FIG. 16, the mobile device 1200 according to the third embodiment comprises, as a functional configuration, an accelerometer 1206, the display module 102, the touch panel controller 119, the graphics controller 118, and the communication module 123, and the detection signal input module 211 as a function module 1210. The display module 102, the touch panel controller 119, the graphics controller 118, and the communication module 123 have the same functions as those in the first embodiment.

In the third embodiment, the accelerometer 1206 comprises a touch determination module 1212 and a movement amount change module 1213 as internal modules. The touch determination module 1212 and the movement amount change module 1213 have the same functions as those of the touch determination module 212 and the movement amount change module 213 in the first embodiment. The touch determination module 1212 and the movement amount change module 1213 may be configured as either hardware or software.

The accelerometer 1206 detects magnitude and direction of acceleration, and obtains an amount and a direction of movement of the mobile device 1200 from the magnitude and the direction of acceleration. The touch determination module 1212 determines, from input received from the touch panel controller 119, whether there is a touch operation on the mobile device 1200. When determining that there is a touch operation, the touch determination module 1212 obtains the touch count. The movement amount change module 1213 changes the amount of movement to a smaller value when the touch count is a larger number. The accelerometer 1206 sends the amount of movement after change and the direction of movement as a detection signal to the detection signal input module 211 of the function module 1210.

The detection signal input module 211 sends the detection signal (the direction and the amount of movement) received from the accelerometer 1206 to the communication module 123. The communication module 123 transmits the direction and the amount of movement to the digital television 200. The digital television 200 receives the direction and the amount of movement, and performs the same processing as that described in the first embodiment.

In the third embodiment, a module in the accelerometer receives a detection signal and obtains an amount of movement of the mobile device 100, and the module changes the amount of movement depending on a state of contact of a touch operation performed on the display 102a. This provides the same advantageous effects as those of the first embodiment, and also reduces a processing load on the function module 1210.

### Fourth Embodiment

In the first to the third embodiments and the modifications, the mobile device 100 and the mobile device 1200 change the amount of movement depending on a state of contact of a touch operation. In a fourth embodiment, the digital television 200 changes the amount of movement depending on a state of contact of a touch operation.

The mobile device 100 according to the fourth embodiment has the same hardware configuration as that of the first embodiment. The mobile device 100 according to the fourth embodiment comprises, as a functional configuration, the detection signal input module 211 in the function module 210, and does not comprise a touch determination module and a movement amount change module. Accordingly, the detection signal input module 211 obtains an amount and a direction of movement of the mobile device 100 from a detection signal (magnitude and direction of acceleration) sent from the accelerometer 106, and the communication module 123 transmits a pointing command comprising the amount and the direction of movement, and the touch count to the digital television 200.

The digital television 200 according to the fourth embodiment differs from the digital television 200 of the first to the third embodiments with respect to the configuration of the display processor 6. In the digital television 200 according to the fourth embodiment, the communication module 17 receives, from the mobile device 100, a pointing command comprising the amount and the direction of movement as information on the amount of movement, and the touch count. The digital television 200 performs processing in accordance with operation determined on the basis of the amount and the direction of movement received from the mobile device 100. The following describes functions of the digital television 200 in detail.

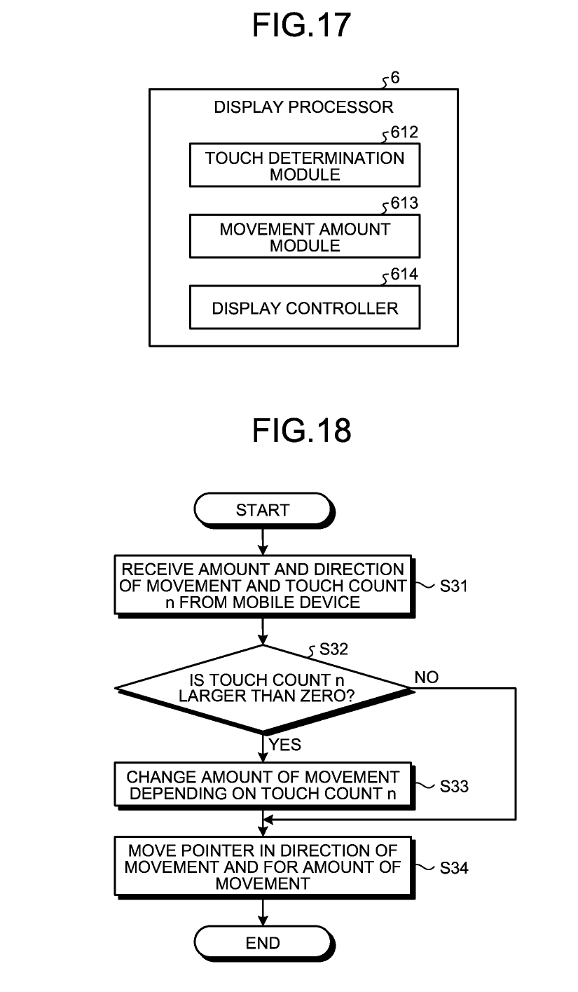

As illustrated in FIG. 17, the display processor 6 according to the fourth embodiment mainly comprises a touch determination module 612, a movement amount change module 613, and a display controller 614.

The touch determination module 612 has the same function as that of the touch determination module 212 of the mobile device 100 according to the first embodiment. That is, the touch determination module 612 obtains, as a state of contact, a touch count received at the communication module 17, and determines the touch count.

The movement amount change module 613 has the same function as that of the movement amount change module 213 of the mobile device 100 in the first embodiment. That is, the movement amount change module 613 changes the amount of movement specified in a pointing command received at the communication module 17 depending on the touch count. Specifically, the movement amount change module 613 changes the amount of movement to a smaller value when the touch count is a larger number.

The display controller 614 controls display on the display module 7. In the fourth embodiment, in particular, the display controller 614 moves the pointer on the display module 7 in the direction of movement obtained at the communication module 17 for the amount of movement changed at the movement amount change module 613, and displays the pointer.

Next, with reference to FIG. 18, described is display control processing performed by the digital television 200 according to the fourth embodiment that is configured as described above.

First, the communication module 17 receives an amount and a direction of movement, and a touch count n from the mobile device 100 (S31). Then, the touch determination module 612 determines whether the received touch count n is larger than zero, that is, whether there is a touch operation on the mobile device 100 (S32).

When the touch determination module 612 determines that the touch count is zero (No at S32), the process proceeds to S34. At S34, the display controller 614 moves the pointer on the display module 7 in a direction of movement for an amount of movement specified in a pointing command, and displays the pointer (S34).

When the touch determination module 612 determines, at S32, that the touch count n is larger than zero (Yes at S32), the movement amount change module 613 changes the amount of movement contained in the pointing command received at the communication module 17 according to the formula 1 above (S33). Thus, the amount of movement is changed depending on the touch count.

The display controller 614 moves the pointer on the display module 7 in the direction of movement received from the mobile device 100 for the amount of movement thus changed, and displays the pointer (S34).

The touch determination module 612 and the movement amount change module 613 may have the same configuration as that of the touch determination module 212 and the movement amount change module 213 of the mobile device 100 according to the second embodiment. In this case, the communication module 17 receives a pointing command comprising the amount and the direction of movement, and coordinates of a touch position from the mobile device 100. The touch determination module 612 obtains the coordinates of a touch position as a state of contact, and determines the coordinates of a touch position. The movement amount change module 613 changes the amount of movement specified in the pointing command depending on the coordinates of a touch position as a state of contact. Specifically, the movement amount change module 613 changes the amount of movement to a smaller value as the coordinates of a touch position shift from the lower end to the upper end of the display 102a.

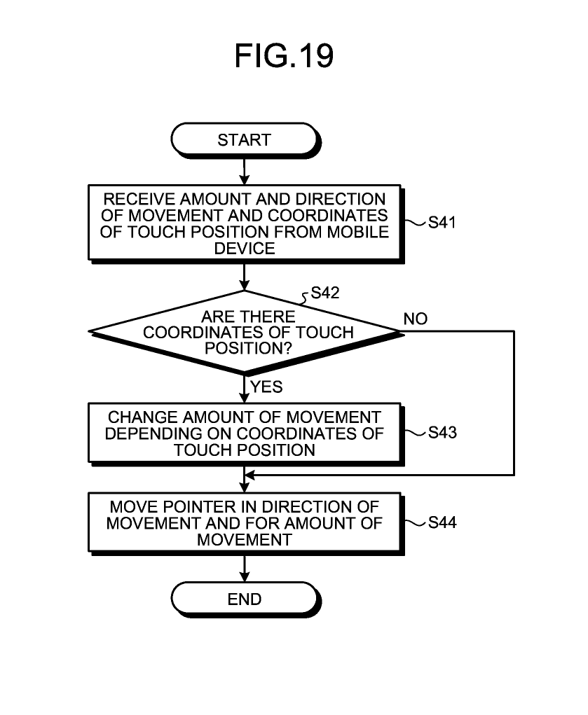

With reference to FIG. 19, the following describes display control processing performed by the digital television 200 in the fourth embodiment in this case.

First, the communication module 17 receives an amount and a direction of movement and coordinates of a touch position from the mobile device 100 (S41). When there is no touch operation on the mobile device 100, coordinates of a touch position is not transmitted to the digital television 200, thus not comprised in data received at the communication module 17. The touch determination module 612 then determines whether the received data comprises coordinates of a touch position, that is, whether there is a touch operation on the mobile device 100 (S42).

When the touch determination module 612 determines that the data does not comprise coordinates of a touch position (No at S42), the process proceeds to S44. At S44, the display controller 614 moves the pointer on the display module 7 in a direction of movement for an amount of movement specified in a pointing command, and displays the pointer (S44).

When the touch determination module 612 determines, at S42, that the data comprises coordinates of a touch position (Yes at S42), the movement amount change module 613 changes the amount of movement specified in the pointing command received at the communication module 17 depending on the coordinates of a touch position (S43).

The display controller 614 moves the pointer on the display module 7 in the direction of movement specified in the pointing command for the amount of movement thus changed, and displays the pointer (S44).

In the fourth embodiment, when a user moves the mobile device 100 while touching the display 102a (touch panel 102b) to move the pointer on the display module 7 of the digital television 200, the amount of movement of the mobile device 100 is changed depending on a state of contact such as a touch count or coordinates of a touch position to change the amount of movement of the pointer. This allows, as in the cases of the first and the second embodiments, the user to easily adjust control of the electronic device such as the digital television 200 based on movement of the mobile device 100. In the fourth embodiment, the digital television 200 changes the amount of movement depending on a state of contact to change the amount of movement of the pointer, thereby reducing a processing load on the mobile device 100.

The modules of the function modules 210 and 1210 of the mobile devices 100 and 1200 according to the first to the third embodiments can be implemented by either hardware or software.

When the modules of the function modules 210 and 1210 of the mobile devices 100 and 1200 according to the first to the third embodiments are implemented by software, a device control program is executed to implement the modules.

The device control program executed in the mobile device 100 according to the first to the third embodiments above is provided as a computer program product by being pre-installed in the non-volatile memory 120.

The device control program executed in the mobile device 100 of the first to the third embodiments above may be provided as a computer program product by being recorded in a computer-readable recording medium, such as a CD-ROM, a flexible disk (FD), a CD-R, or a digital versatile disc (DVD), as files in an installable or an executable format.

The device control program executed in the mobile device 100 of the first to the third embodiments above may alternatively be provided as a computer program product by being stored on a computer connected to a network such as the Internet and by being downloaded via the network. The device control program executed in the mobile device 100 of the first to the third embodiments may be provided or distributed as a computer program product via a network such as the Internet.

The device control program executed by the mobile device 100 in the first to the third embodiments above is implemented as a module configuration comprising modules (the detection signal input module 211, the touch determination module 212, the movement amount change module 213) described above. As the hardware configuration, the CPU 116 reads the device control program from the non-volatile memory 120 and executes the device control program to load the above described modules onto the main memory, so that the detection signal input module 211, the touch determination module 212, and the movement amount change module 213 are generated on the RAM 121.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for controlling an electronic device by a device controller, the method comprising:
detecting first movement of the device controller;
receiving input of a contact operation performed by a user on a screen of the device controller; and
transmitting, to the electronic device to be operated by the device controller, information on an amount of second movement determined by using an amount of the first movement, wherein
the amount of the second movement differs depending on a state of contact of the contact operation on the screen during detecting the first movement of the device controller.

2. The method for controlling an electronic device of claim 1, wherein
the state of contact comprises at least number of contact points on the screen, and
the amount of the second movement differs depending on the number of contact points.

3. The method for controlling an electronic device of claim 2, wherein the amount of the second movement has a smaller value when the number of contact points is a larger number.

4. The method for controlling an electronic device of claim 1, wherein
the state of contact comprises at least a contact position on the screen, and
the amount of the second movement differs depending on the contact position.

5. The method for controlling an electronic device of claim 4, wherein the amount of the second movement has a smaller value when the contact position is closer to an end of the screen.

6. A device controller, comprising:
a detector configured to detect first movement of the device controller;
an input module configured to enable a user to input a contact operation on a screen of the device controller; and
a transmitter configured to transmit, to an electronic device to be operated by the device controller, information on an amount of second movement determined by using an amount of the first movement, wherein
the amount of the second movement differs depending on a state of contact of the contact operation on the screen during detecting the first movement of the device controller.

7. The device controller of claim 6, wherein
the state of contact comprises at least number of contact points on the screen, and
the amount of the second movement differs depending on the number of contact points.

8. The device controller of claim 6, wherein
the state of contact comprises at least a contact position on the screen, and
the amount of the second movement differs depending on the contact position.

9. The device controller of claim 6, wherein the detector changes the amount of the second movement depending on the state of contact.

10. The device controller of claim 6, wherein
the detector is an accelerometer, and
the input module is a touch panel.

11. A computer program product having a non-transitory computer readable medium including programmed instructions, wherein the instructions, when executed by a computer, cause the computer to perform:
detecting first movement of a device controller;
receiving input of a contact operation by a user on a screen of the device controller; and
transmitting, to an electronic device to be operated by the device controller, information on an amount of second movement determined by using an amount of the first movement, wherein
the amount of the second movement differs depending on a state of contact of the contact operation on the screen during detecting the first movement of the device controller.

12. The computer program product of claim 11, wherein
the state of contact comprises at least number of contact points on the screen, and
the amount of the second movement differs depending on the number of contact points.

13. The computer program product of claim 11, wherein
the state of contact comprises at least a contact position on the screen, and
the amount of the second movement differs depending on the contact position.

14. An electronic device comprising:
a receiver configured to receive, from an device controller, information on an amount of second movement determined by using an amount of first movement of the device controller, and
a processor configured to perform processing in accordance with operation determined based on the information on an amount of the second movement, wherein
the amount of the second movement differs depending on a state of contact on a screen of the device controller during detecting the first movement of the device controller.
